(19) United States
(12) Patent Application Publication
(10) Pub. No.: US 2018/0300690 A1
(43) Pub. Date: Oct. 18, 2018

(54) METHOD OF SCHEDULING PLAN WITH DIGITAL COMMUNICATION SYSTEM

(71) Applicant: ZEROPLUS TECHNOLOGY CO., LTD., NEW TAIPEI CITY (TW)

(72) Inventor: CHIU-HAO CHENG, KAOHSIUNG CITY (TW)

(73) Assignee: ZEROPLUS TECHNOLOGY CO., LTD., NEW TAIPEI CITY (TW)

(21) Appl. No.: 15/650,465

(22) Filed: Jul. 14, 2017

(30) Foreign Application Priority Data
Apr. 12, 2017 (TW) 106112196

(51) Int. Cl. G06Q 10/10; G06Q 10/06

(52) U.S. Cl. CPC G06Q 10/1093; G06Q 10/06

(57) ABSTRACT

A method of scheduling plan with digital communication system is disclosed. The digital communication system includes a server, a first user, and a second user, which are signal connected. The first user and the second user respectively restore a first calendar and a second calendar. The method includes the following steps. The server retrieves the calendars stored in the users, and analyzes and obtains periods unscheduled in the calendars, and then sends the periods unscheduled to the first user. The first user selects one of the periods, and inputs a plan information, and sends said period and the plan information to the server. The server sends the received period and the plan information to the second user. The second user enters the period and the plan information to the second calendar.

### BACKGROUND OF THE INVENTION

### 1. Technical Field

The present invention relates generally to plan scheduling, and more particularly to a method of scheduling plans with a digital communication system which automatically collates and provides periods unscheduled by all users for users to select.

### 2. Description of Related Art

In order to facilitate the management and control for schedule, most people commonly use physical items such as paper, calendar, and desk calendar, to record the related periods and plan information. However, physical items are sometimes not portable and would probably be lost. Thus, with the progress of science and technology, people start using digital communication systems such as computer, cell phone, and electronic calendar in cloud storage, to record the plan information, and to instantly view and update through network transmission.

However, with the scheduling methods mentioned above, people can only search schedules of themselves. Therefore, if people would like to schedule a plan with others, e.g., traveling and visiting customers together, they has to check other's schedules one by one. Accordingly, because people cannot arrange and check schedules of themselves and others at the same time, it is inconvenient to schedule plan, and thus the scheduling would be delayed.

### BRIEF SUMMARY OF THE INVENTION

In view of the above, the primary objective of the present invention is to provide a method of scheduling plans with a digital communication system, which automatically collates and provides periods unscheduled by all users for users to select and schedule.

The present invention provides a method of scheduling plan with digital communication system, wherein the digital communication system includes a server, a first user, and a second user. The server is signal connected to the first user and the second user, and the first user and the second user respectively restore a first calendar and a second calendar. Each of the first calendar and the second calendar includes information about unscheduled periods. The method includes the steps of:
A. the server retrieves the calendars stored in the first user and the second user, and analyzes and obtains periods unscheduled in the first calendar and the second calendar according to information about unscheduled periods in said retrieved calendars;
B. the server sends the periods unscheduled in the first calendar and the second calendar to the first user;
C. the first user selects at least one of the periods unscheduled in the first calendar and the second calendar, and inputs a plan information, and sends said period and the plan information to the server;
D. the server sends the received period and the plan information to the second user; and
E. the second user enters the period and the plan information to the second calendar.

Accordingly, in the step C or the step E, the first user enters the period and the plan information to the first calendar.

Whereby, with the aforementioned design, the system can automatically collate and provide periods to be scheduled by each user through the server 10, which directly and instantly provides periods to be selected and arranges the plan. Accordingly, the method is helpful for drastically reducing the required time and effort.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a digital communication system applied for a first embodiment of the present disclosure;

FIG. 2 is a flow chart of the first embodiment, showing the method of scheduling plan with digital communication system;

FIG. 3 is a schematic diagram of the chat room window, showing the first user makes a scheduling request through the chat room window;

FIG. 4 is a schematic diagram showing the server analyzes each calendar;

FIG. 5 is a window display to be operated by the first user in the first embodiment;

FIG. 6 is a window display to be operated by the second user in the first embodiment;

FIG. 7 is a flow chart of a second embodiment, showing the method of scheduling plan with digital communication system;

FIG. 8 is a window display to be operated by the second user in the second embodiment;

FIG. 9 is a flow chart of a third embodiment, showing the method of scheduling plan with digital communication system;

FIG. 10 is a digital communication system applied for a fourth embodiment of the present disclosure; and

FIG. 11 is a flow chart of the fourth embodiment, showing the method of scheduling plan with digital communication system.

### DETAILED DESCRIPTION OF THE INVENTION

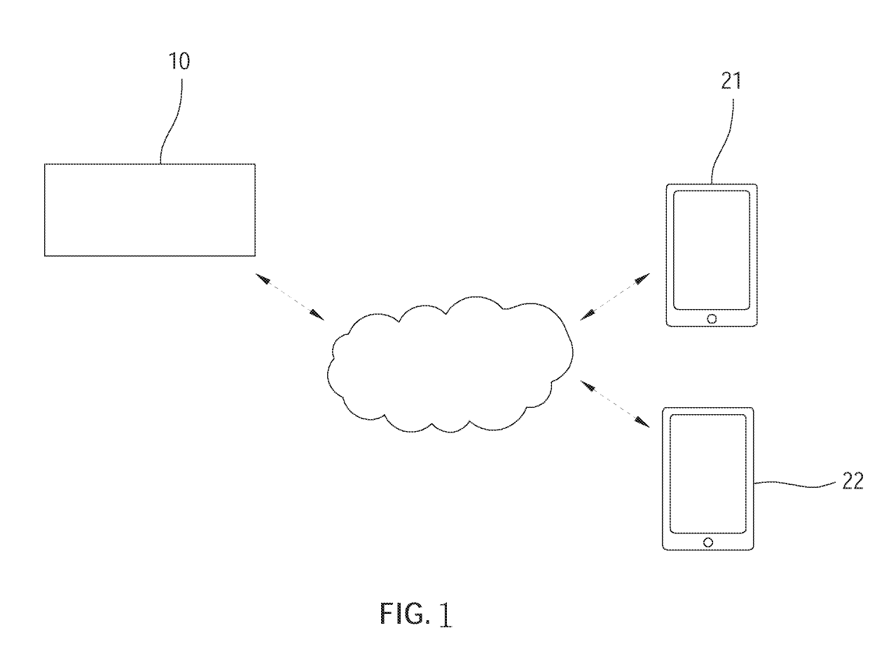

As shown in FIG. 1, a digital communication system applied for a first embodiment of the present disclosure mainly includes a server 10, a first user 21, and a second user 22. The first user 21 and the second user 22 contain communication software downloaded respectively, which store a first calendar and a second calendar respectively. Each of the calendars contains information about scheduled periods and plans as well as unscheduled periods. Additionally, the first user 21 and the second user 22 are adapted to be signal connected to the server 10 by using the communication software through internet. In more details, in the first embodiment, the first user 21 and the second user 22 are but not limited to two smart phones respectively. In other embodiments, the user can be a tablet, a desktop computer, a laptop, or other electronic devices adapted to perform digital signal exchange.

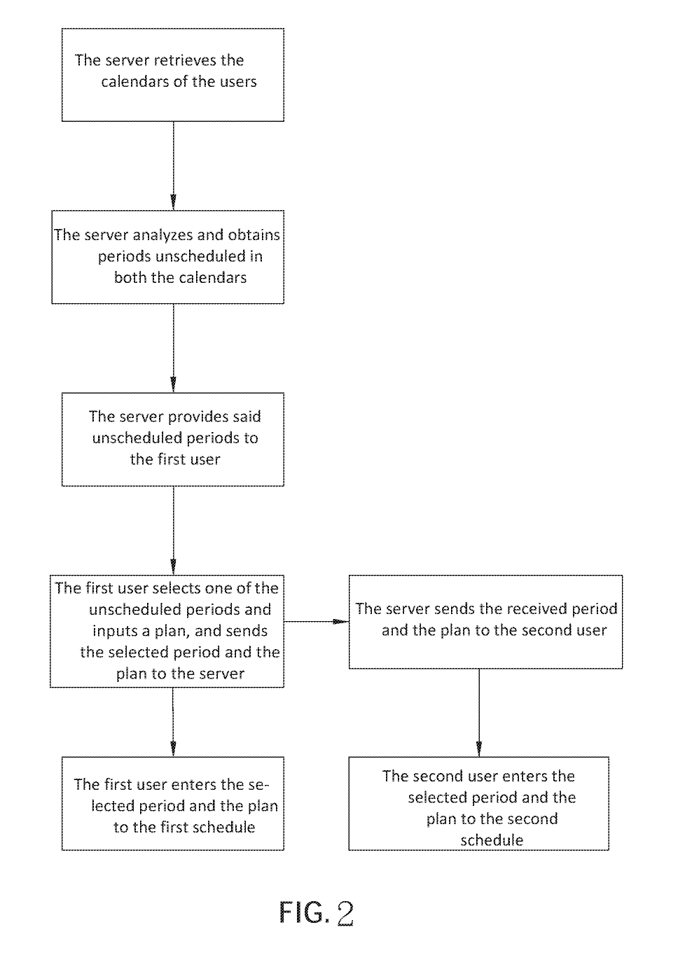

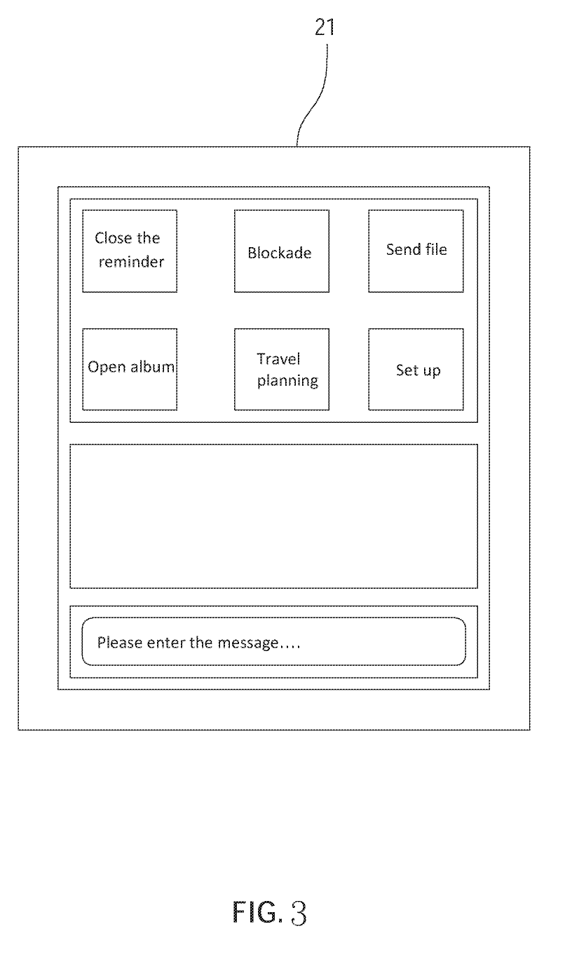

As illustrated in FIG. 2, if the operator of the first user 21 decides to invite the operator of the second user 22 to participate in a plan, the operator of the first user 21 could use the communication software to inform the second user 22 to be signal connected to the server 10 together. Practically, the operator of the first user 21 opens the chat room window, and presses the request button of the travel planning shown in FIG. 3. Then, the digital communication system could perform the method of scheduling plans which includes the following steps.

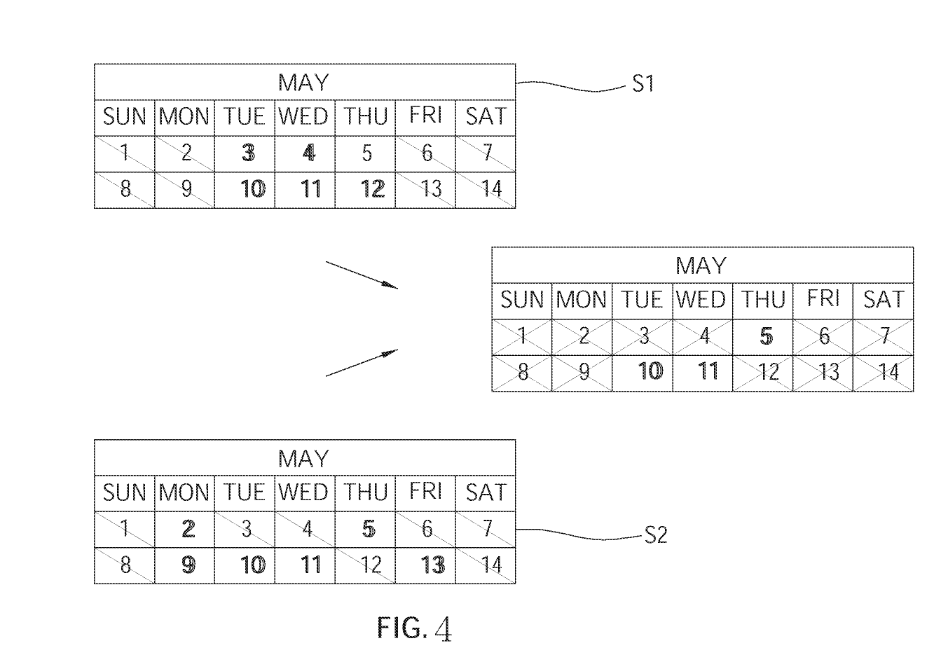

Once the first user 21 and the second user 22 open the communication software and are signal connected to the server 10, the server 10 retrieves the calendars stored in the first user 21 and the second user 22, i.e., the first calendar S1 and the second calendar S2. Next, as shown in FIG. 4, the server 10 analyzes and obtains periods unscheduled in the first calendar S1 and the second calendar S2 according to the information about unscheduled periods in the retrieved first and second calendars S1, S2. The obtained periods can be arranged by the first user 21 and the second user 22 together.

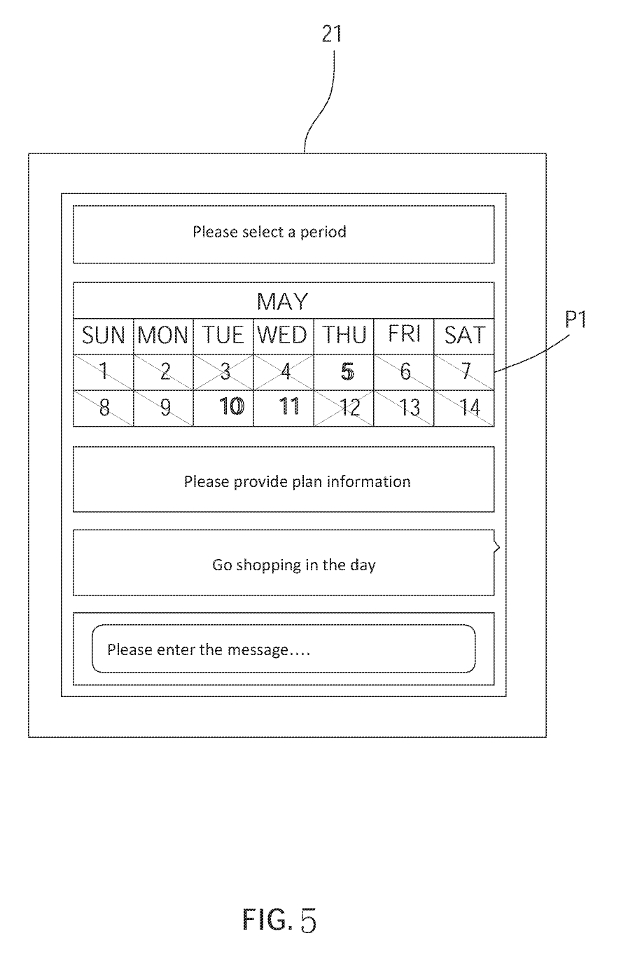

The server 10 sends the periods unscheduled in both the first calendar S1 and the second calendar S2 to the first user 21 for displaying. In the first embodiment, the server sends a first calendar chart P1 shown in FIG. 5 to the chat room window of the first user 21 for displaying. Moreover, the first calendar chart P1 shows images related to the periods unscheduled in the first calendar S1 and the second calendar S2. Additionally, for the convenience of the operator of the first user 21 to confirm the schedule and the related periods, the first calendar chart P1 also displays the original plan in the first calendar S1.

After the first user 21 selects one of the unscheduled periods in the first calendar chart P1 and inputs plan information, the first user 21 sends the selected period and the plan information to the server 10. Then, the first user 21 enters the selected period and the plan information to the first calendar S1 for recording.

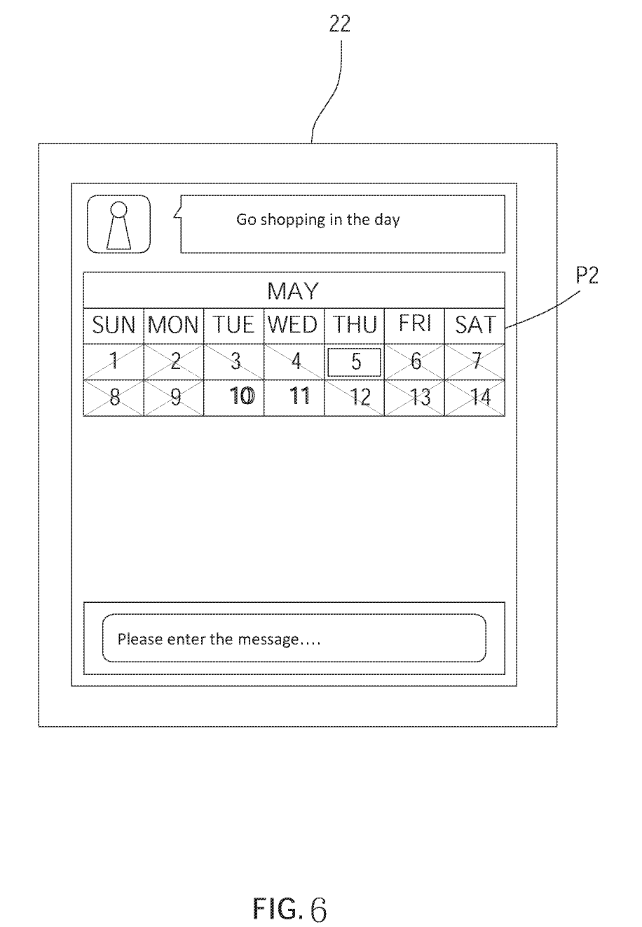

The server 10 sends the received period and the plan information to the second user 22. In the first embodiment, the server 10 sends a second calendar chart P2 shown in FIG. 6 to the chat room window of the second user 22 for displaying. It is known from FIG. 6 that the second calendar chart P2 shows images related to the periods unscheduled in the first calendar S1 and the second calendar S2, as well as the period selected by the first user 21 and the related plan information, wherein the display model of the selected period is different from that of other periods. In the first embodiment, the selected period in the second calendar chart P2 is marked by a frame, and the related plan information is also shown. However, in other embodiments, the selected period can be marked by other modes such as color changing, flicking, and size changing. In addition, for the convenience of the operator of the first user 21 to confirm the schedule and the related periods, the second calendar chart P2 also displays the original plan in the second calendar S2.

And then, the second user 22 enters the selected period and the plan information to the second calendar S2 for recording.

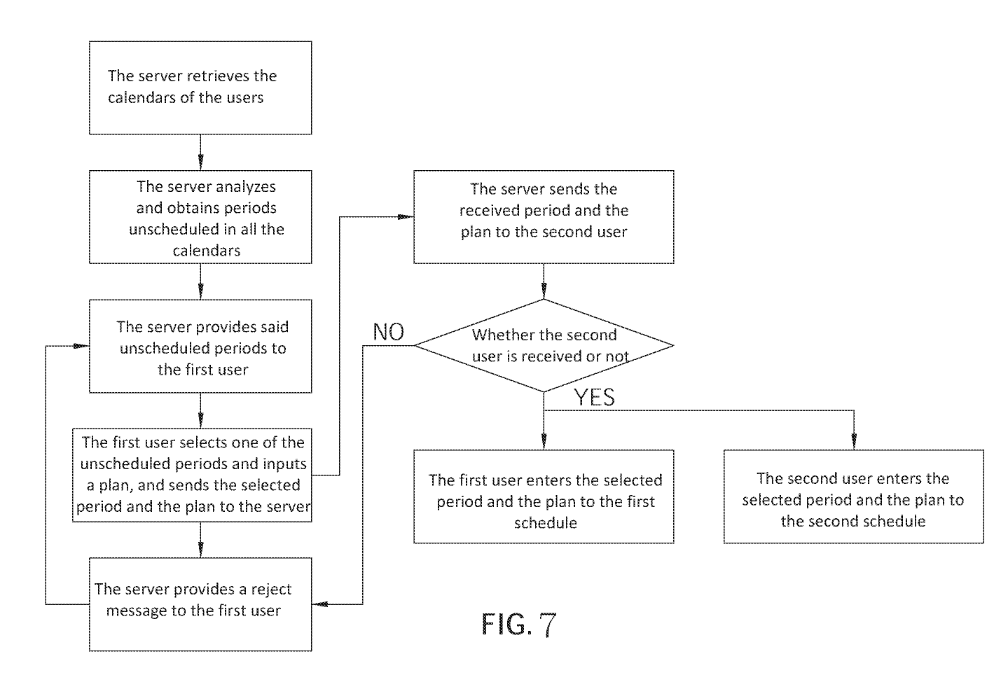

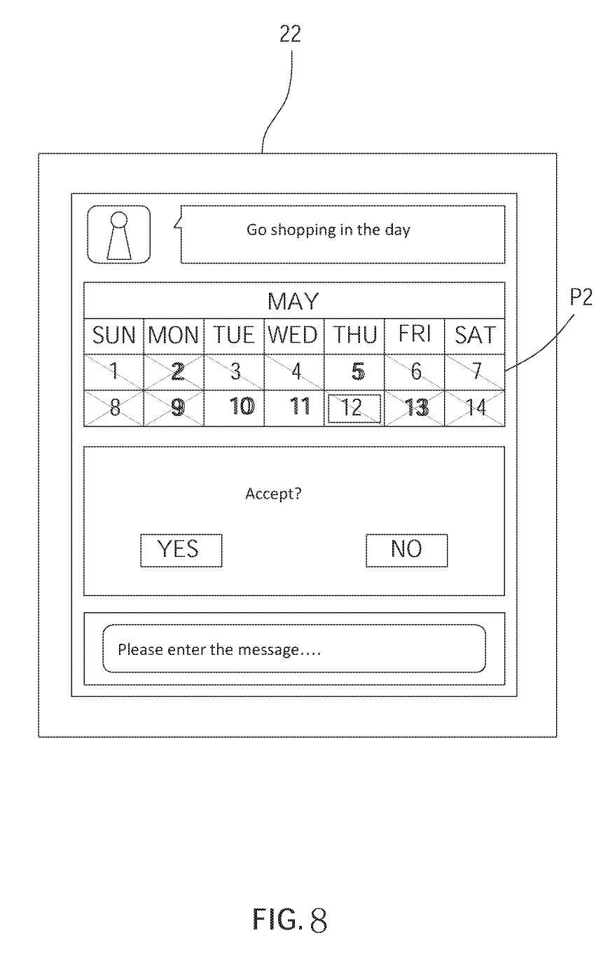

As shown in FIG. 7, except that the first user 21 directly determines the scheduled period, when the server 10 sends the period and the plan information to the second user 22, the server 10 sends an enquiry message shown in FIG. 8 to the chat room window of the second user 22 for asking the second user 22 whether to accept the period and the plan information or not.

If the second user 22 accepts, the second user 22 would enter the selected period and the plan information to the second calendar S2 for recording. After the second user 22 accepts, the first user 21 enters the selected period and the plan information to the first calendar S1 for recording. On the contrary, in the second user 22 does not accept, the server 10 sends a reject message to the chat room window of the first user 21, which means the second user 22 refuses to enter the selected period and the plan information to the second calendar S2. After the operator of the first user 21 receives the reject message, the operator can select another period.

In addition, in this embodiment, the first user 21 can also select a plurality of suitable periods at the same time, and send the periods to the server 10. After the server 10 sends the periods to the second user 22, the second user 22 selects one of the periods, and enters the selected period and the plan information to the second calendar S2, as well as sends the selected period back to the server 10 to inform the server 10. After the first user 21 receives the period selected by the second user 22, the first user 21 enters the selected period and the plan information to the first calendar S1 for recording.

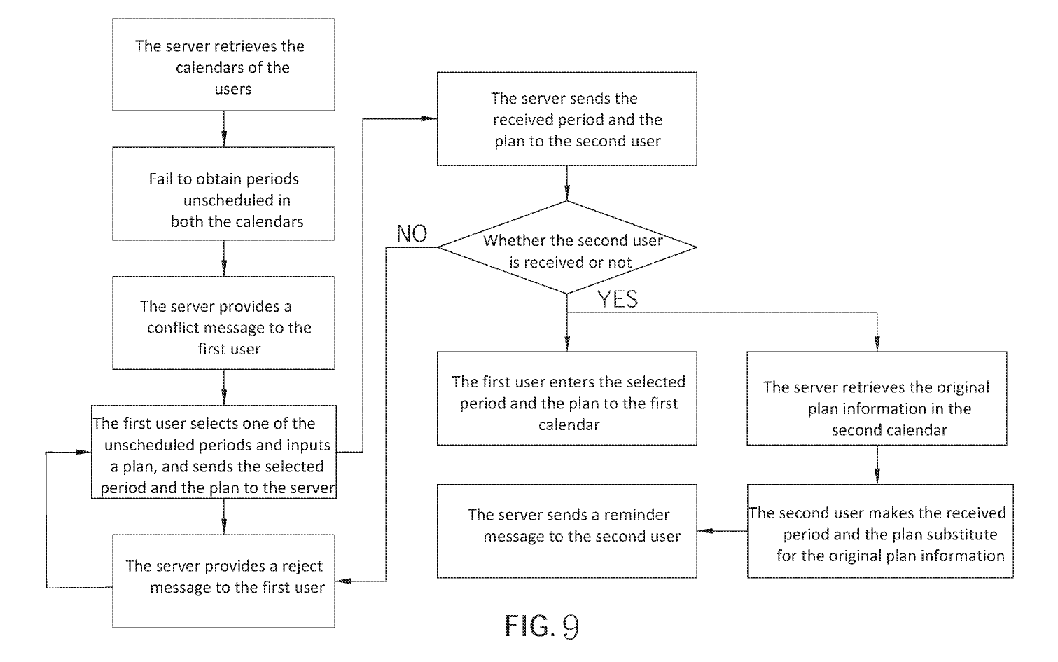

Additionally, as shown in FIG. 9, after the server 10 analyzes, if there is no periods unscheduled in the first calendar S1 and the second calendar S2, the server 10 would sends a conflict message to the first user 21, which means there is no periods can be arranged by the first user 21 and the second user 22 together.

After the first user 21 receives the conflict message, the first user 21 selects one of the unscheduled periods and inputs a plan information, and sends the selected period and the plan information to the server 10. After that, the server 10 sends the received period and the plan information to the second user 22, and also sends a rescheduled message to ask the second user 22 whether to reschedule according to said period and the plan information. If the second user 22 refuses to reschedule, the server 10 would send a reject message to the first user 21, which means the second user 22 refuses to enter the selected period and the plan information to the second calendar S2. If the second user 22 decides to reschedule, the second user 22 would enter the selected period and the plan information to the second calendar S2 to substitute the original plan information.

After the aforementioned rescheduling, in order to avoid the operator of the second user 22 from forgetting to reschedule or cancel the original plan with the relevant personnel, when the second user 22 accepts the rescheduling, and before the second user 22 makes the period and the plan information substitute for the original plan information, the server 10 would retrieve the original plan information in the second calendar S2. After the original plan information is substituted, the server 10 sends a reminder message to the chat room window of the second user 22 for reminding the operator of the second user 22 to reschedule or cancel the original plan with the relevant personnel.

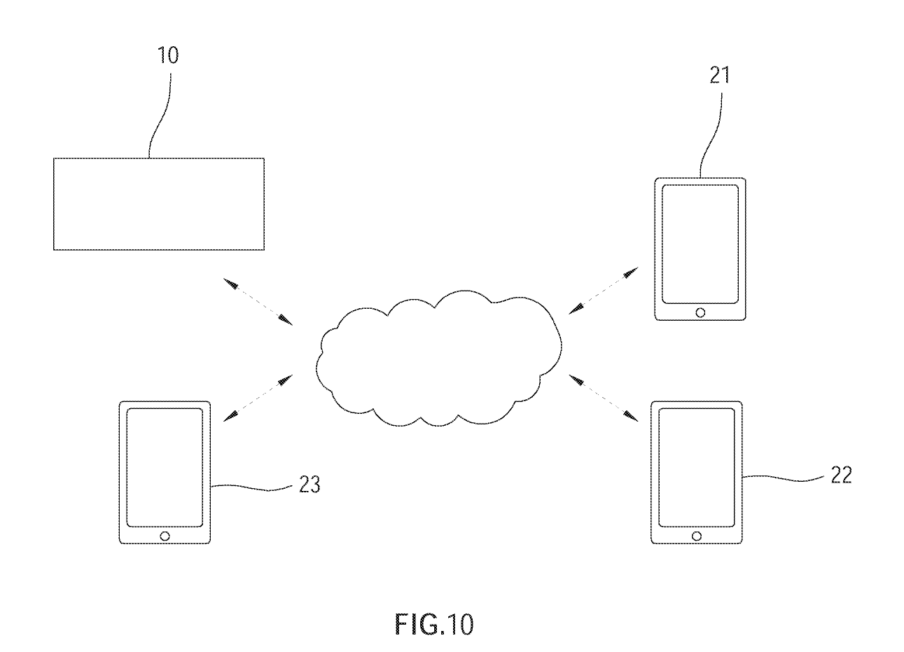

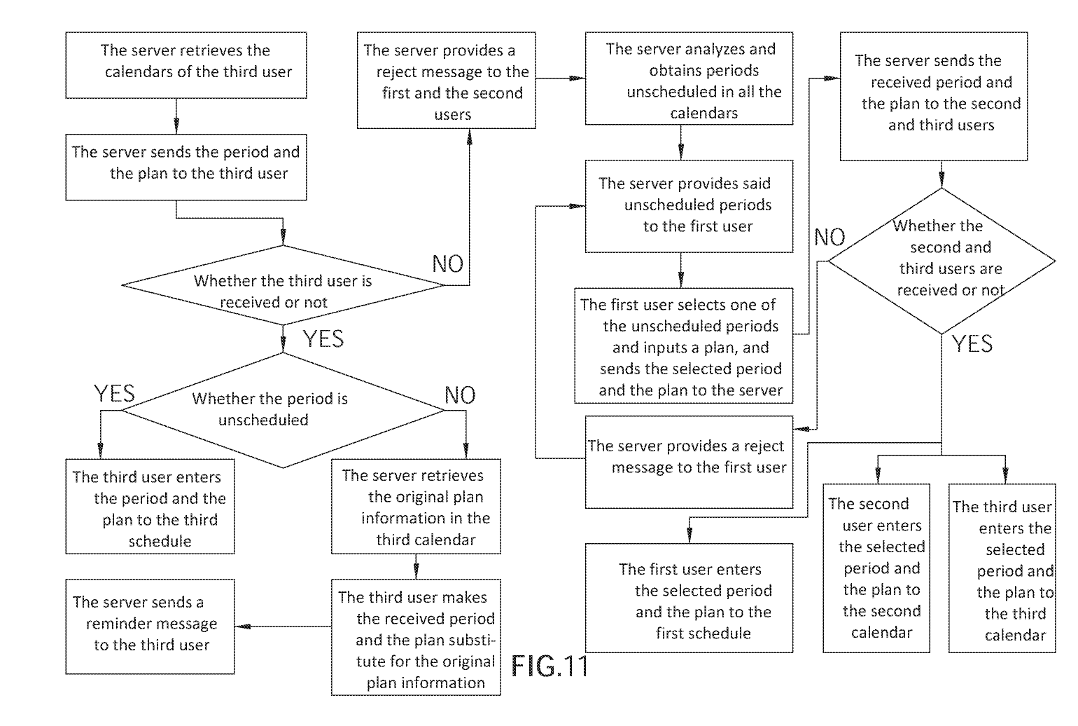

Moreover, as shown in FIG. 10, after the first user 21 and the second user 22 arrange a common plan according to the aforementioned method, the first user 21 or the second user 22 can further invite a third user 23 to participate in a plan through the communication software, wherein the third user also contains communication software downloaded which stores a third calendar. If the third user 23 accepts the invitation form the first user 21 or the second user 22 through the signal from the communication software, the first user 21, the second user 22, and the third user 23 would be signal connected to the server 10 through internet. As shown in FIG. 11, the server 10 would then retrieve the third calendar stored in the third user 23. Moreover, according to the information about unscheduled period in the third calendar, the server 10 analyzes whether the period of the common plan of the first user 21 and the second user 22 overlaps the period unscheduled in the third calendar.

If the period of the common plan of the first user 21 and the second user 22 overlaps the period unscheduled in the third calendar, the operator of the third user 23 could participate in the plan with the operators of the first user 21 and the second user 22. In this situation, the server 10 sends the period and the plan information to the third user 23, and also sends an enquiry message to the chat room window of the third user 23 to ask whether the third user 23 accepts the period and the relevant plan information. If the third user 23 accepts, the third user 23 would enter the period and the plan information to the third calendar. On the contrary, if the third user 23 refuses, the server would sends a reject message to the chat room windows of the first user 21 and the second user 22, which means the third user 23 refuses to participate in the same plan.

In addition, if the period of the common plan of the first user 21 and the second user 22 does not overlap the period unscheduled in the third calendar, which means the operator of the third user 23 fails to participate in the common plan with the operators of the first user 21 and the second user 22 according to the original schedule, the server 10 would send the period and the plan information to the chat room window of the third user 23, and send a rescheduled message to ask the third user 23 whether to reschedule. If the third user 23 refuses to reschedule, the server 10 would send a reject message to the first user 21 and the second user 22, which mean that the third user 23 refuses to participate in the common plan. If the third user 23 decides to reschedule, the third user 23 would input the period and the plan information to the third calendar for substituting the original plan. Moreover, the server 10 would also retrieve the original plan information in the third calendar. After the original plan information of the is substituted by the third user 23, the server 10 generates and sends a reminder message to the chat room window of the third user 23 for reminding the operator of the third user 232 to reschedule or cancel the original plan with the relevant personnel.

In addition, if the third user 23 refuses to reschedule, the server 10 could further analyze and obtain periods unscheduled in all the first calendar, the second calendar, and the third calendar according to the information about the unscheduled periods of the three calendars. Next, the server 10 would send the obtained periods to the first user 21. After that, the first user 21 selects another one of the periods unscheduled in the three calendars, and sends the selected period to the server 10.

Then, the server 10 sends the received another period and the relevant plan information to the second user 22 and the third user 23. If both the second user 22 and the third user 23 accept the another period, the first user 21, the second user 22, and the third user 23 would respectively enter the another period and the plan information in the first calendar, the second calendar, and the third calendar. Moreover, the first user 21 and the second user 22 would cancel the period and the plan information, which are originally entered in the first calendar and the second calendar.

Whereby, with the design of the aforementioned embodiments, the system can automatically collate and provide periods to be scheduled by each user through the server 10, which directly and instantly provides periods to be selected and arranges the plan. Accordingly, the method is helpful for drastically reducing the required time and effort.

It must be pointed out that the embodiments described above are only some preferred embodiments of the present invention. All equivalent methods which employ the concepts disclosed in this specification and the appended claims should fall within the scope of the present invention.

What is claimed is:

1. A method of scheduling plan with digital communication system, wherein the digital communication system comprises a server, a first user, and a second user; the server is signal connected to the first user and the second user, and the first user and the second user respectively restore a first calendar and a second calendar, wherein each of the first calendar and the second calendar comprises information about unscheduled periods, comprising the steps of:
A. the server retrieves the calendars stored in the first user and the second user, and analyzes and obtains periods unscheduled in the first calendar and the second calendar according to information about unscheduled periods in said retrieved calendars;
B. the server sends the periods unscheduled in the first calendar and the second calendar to the first user;
C. the first user selects at least one of the periods unscheduled in the first calendar and the second calendar, and inputs a plan information, and send said period and the plan information to the server;
D. the server sends the received period and the plan information to the second user; and
E. the second user enters the period and the plan information to thr second calendar.

2. The method of claim 1, wherein in the step C, the first user enters the period and the plan information to the first calendar.

3. The method of claim 1, wherein in the step E, the first user enters the period and the plan information to the first calendar.

4. The method of claim 3, wherein in the step D, the server further sends an enquiry message to ask the second user whether to accept the period and the plan information; if the second user accepts, performs the step E; if the second user refuses, the server would send a reject message to the first user, where the second user refuses to enter the period and the plan information to the second calendar, and performs the step B to step D.

5. The method of claim 1, wherein in the step C, the first user selects a plurality of periods and sends said periods to the server; in the step D, the server sends the plurality of periods to the second user; in the step E, the second user selects one of the plurality of periods as a selected period, and enters the selected period and the plan information to the second calendar.

6. The method of claim 5, wherein in the step E, the second user sends the selected period to the server; after the step E, the server sends the selected period to the first user, and the first user enters the selected period and the plan information to the first calendar.

7. The method of claim 1, wherein in the step A, if there is no periods unscheduled in the first calendar and the second calendar, the server would send a conflict message to the first user.

8. The method of claim 7, wherein after the first user receives the conflict message, the first user selects one of the periods unscheduled in the first calendar as a selected period, and inputs a plan information and sends the selected period and the plan information to the server; after that, the server sends the selected period and the plan information to the second user, and also sends a rescheduled message to ask the second user whether to reschedule according to the selected period and the plan information; if the second user accepts, the second user would enter the selected period and the plan information to the second calendar to substitute an original plan; if the second user refuses, the server would send a reject message to the first user, where the second user refuses to enter the selected period and the plan information to the second calendar.

9. The method of claim 8, wherein before the second user enters the selected period and the plan information to the second calendar to substitute the original plan, the server retrieves information about the original plan in the second calendar; after the second user enters the selected period and the plan information to the second calendar to substitute the original plan, the server generates and sends a reminder message to the second user according to the information about the original plan.

10. The method of claim 1, wherein in the step B, the server sends a first calendar chart to the first user; the first calendar chart shows periods unscheduled in the first calendar and the second calendar.

11. The method of claim 10, wherein the first calendar chart further shows periods scheduled in the first calendar.

12. The method of claim 10, wherein in the step D, the server sends a second calendar chart to the second user; the second calendar chart shows periods unscheduled in the first calendar and the second calendar, and the period and the plan information, wherein a display model of the period is different from display models of other periods.

13. The method of claim 12, wherein the second calendar chart further shows periods scheduled in the second calendar.

14. The method of claim 2, wherein after the step E, the server is further signal connected to a third user, and retrieves a third calendar of the third user; according to the information about unscheduled period in the third calendar, the server analyzes whether the period overlaps the unscheduled period in the third calendar; if the period overlaps the unscheduled period in the third calendar, the server would sends the period and the plan information to the third user, and the third user would enter the period and the plan information to the third calendar.

15. The method of claim 3, wherein after the step E, the server is further signal connected to a third user, and retrieves a third calendar of the third user; according to the information about unscheduled period in the third calendar, the server analyzes whether the period overlaps the unscheduled period in the third calendar; if the period overlaps the unscheduled period in the third calendar, the server would sends the period and the plan information to the third user, and the third user would enter the period and the plan information to the third calendar.

16. The method of claim 14, wherein if the period overlaps the unscheduled period in the third calendar, the server would further send an enquiry message to ask the third user whether to accept the period and the plan information; if the third user accepts, the third user would enter the period and the plan information to the third calendar; if the third user refuses, the server would send a reject message to the first user and the second user, where the third user refuses to enter the period and the plan information to the third calendar.

17. The method of claim 15, wherein if the period overlaps the unscheduled period in the third calendar, the server would further send an enquiry message to ask the third user whether to accept the period and the plan information; if the third user accepts, the third user would enter the period and the plan information to the third calendar; if the third user refuses, the server would send a reject message to the first user and the second user, where the third user refuses to enter the period and the plan information to the third calendar.

18. The method of claim 14, wherein if the period does not overlap the period unscheduled in the third calendar, the server would send the period and the plan information to the third user, and send a rescheduled message to ask the third user whether to reschedule; if the third user accepts rescheduling, the third user would enter the period and the plan information to the third calendar for substituting the original plan; if the third user refuses to reschedule, the server would send a reject message to the first user and the second user, where the third user refuses to enter the period and the plan information to the third calendar.

19. The method of claim 15, wherein if the period does not overlap the period unscheduled in the third calendar, the server would send the period and the plan information to the third user, and send a rescheduled message to ask the third user whether to reschedule; if the third user accepts rescheduling, the third user would enter the period and the plan information to the third calendar for substituting the original plan; if the third user refuses to reschedule, the server would send a reject message to the first user and the second user, where the third user refuses to enter the period and the plan information to the third calendar.

20. The method of claim 18, wherein if the third user refuses to reschedule, the server would further analyze and obtain periods unscheduled in the first calendar, the second calendar, and the third calendar, according to the information about the periods unscheduled in the first calendar, the second calendar, and the third calendar; the server would then send said periods to the first user; the first user selects another one of the periods unscheduled in the three calendars, and sends the another period to the server, and cancels the period and the plan information, which are originally entered in the first calendar; the server sends the another period and the plan information to the second user and the third user; the first user, the second user, and the third user enter the another period and the plan information to the first calendar, the second calendar, and the third calendar respectively; the second user cancels the period and the plan information which are entered to the second calendar in the step E.

21. The method of claim 19, wherein if the third user refuses to reschedule, the server would further analyze and obtain periods unscheduled in the first calendar, the second calendar, and the third calendar, according to the information about the periods unscheduled in the first calendar, the second calendar, and the third calendar; the server would then send said periods to the first user; the first user selects another one of the periods unscheduled in the three calendars, and sends the another period to the server, and cancels the period and the plan information, which are originally entered in the first calendar; the server sends the another period and the plan information to the second user and the third user; the first user, the second user, and the third user enter the another period and the plan information to the first calendar, the second calendar, and the third calendar respectively; the second user cancels the period and the plan information which are entered to the second calendar in the step E.

22. The method of claim 20, wherein before the third user enters the period and the plan information to the third calendar for substituting the original plan, the server retrieves information about the original plan in the third calendar; after the third user enters the period and the plan information to the third calendar to substitute the original plan, the server generates and sends a reminder message to the third user according to the information about the original plan.

23. The method of claim 21, wherein before the third user enters the period and the plan information to the third calendar for substituting the original plan, the server retrieves information about the original plan in the third calendar; after the third user enters the period and the plan information to the third calendar to substitute the original plan, the server generates and sends a reminder message to the third user according to the information about the original plan.
